(19) United States
(12) Patent Application Publication
(10) Pub. No.: US 2022/0055450 A1
(43) Pub. Date: Feb. 24, 2022

(54) CABIN HEATER

(71) Applicant: LEXMARK INTERNATIONAL, INC., LEXINGTON, KY (US)

(72) Inventors: PETER ALDEN BAYERLE, LEXINGTON, KY (US); JAMES DOUGLAS GILMORE, GEORGETOWN, KY (US); RUSSELL EDWARD LUCAS, LEXINGTON, KY (US); JERRY WAYNE SMITH, IRVINE, KY (US)

(21) Appl. No.: 17/399,747

(22) Filed: Aug. 11, 2021

Related U.S. Application Data
(60) Provisional application No. 63/067,409, filed on Aug. 19, 2020.

(51) Int. Cl. B60H 1/22

(52) U.S. Cl. CPC B60H 1/2221; B60H 2001/2271; B60H 2001/2278

(57) ABSTRACT

A heater for a passenger cabin includes a body for holding fluid coolant. A top and bottom lid cover the body and at least one heater module resides between the lids to heat the fluid coolant. The heater module has a base substrate with a longitudinally extending resistive trace and conductor to apply an external voltage to the trace for heating. Glass overlies the trace. Various embodiments teach substrates of alumina, aluminum nitride, and four heater modules parallel to one another. The modules mount parallel, perpendicular, or angled to a fluid inlet of the body.

This utility application claims priority from U.S. Provisional Application Ser. No. 63/067,409, filed Aug. 19, 2020, whose entire contents are incorporated herein by reference.

### FIELD OF THE INVENTION

The present disclosure relates to heating passenger cabins in vehicles. It relates further to a heat exchanger having efficient heater modules. Certain heater modules include essentially pure alumina or aluminum nitride bases with thick film printing, including resistive and conductive layers and overlayers of glass. Embodiments teach layout and orientation.

### BACKGROUND

As the global automotive industry shifts toward developing battery powered vehicles to replace fossil fuel vehicles, challenges arise for meeting customer expectations of efficiency and comfort. Specifically, issues abound regarding cabin heating efficiency and response times when ambient temperature is relatively low.

In internal combustion engines, vehicles provide essentially free cabin heating by using waste heat from the engine. Battery powered vehicles, on the other hand, have no such heat source and there exists little waste heat available from other sources. Thus, battery powered vehicles must provide heat from a stand-alone heating device. As heating devices obtain energy from the batteries, artisans have found that efficiency and time-to-temperature critically limit heating functionality. Further, time-to-temperature impacts comfort as occupants in the cabin do not want lengthy times before heating devices deliver warm air.

There currently exists two primary heating devices in battery powered vehicles. One, a heat pump, utilizes a coolant medium to transfer heat to air for introduction into the cabin by an HVAC system. Two, a forced air electric heater, e.g., a heat exchanger, utilizes positive temperature coefficient (PTC) elements as a direct source of heat for cabin air. This disclosure focuses on heat exchangers. Embodiments disclosed herein also find applicability in traditional vehicles having internal combustion engines.

### SUMMARY

A heater for a passenger cabin includes a body. Top and bottom lids cover the body to retain fluid coolant. At least one heater module resides inside the body between the lids to heat the fluid coolant. The heater module has a base substrate with a longitudinally extending resistive trace and conductor to apply an external voltage to the trace for heating. Glass overlies the trace. Various embodiments teach substrates of alumina, aluminum nitride, and heater modules parallel to one another. The modules may mount parallel, perpendicular, or angled to a fluid inlet of the body.

### BRIEF DESCRIPTION OF THE FIGURES

FIG. 1 is a perspective view of a heater for a passenger cabin according to a representative embodiment of the present disclosure;

FIG. 2 is an exploded view of the heater of FIG. 1;

FIG. 3A is an exploded view of an individual heater module for use in the heater of FIG. 1;

FIG. 3B is a perspective topside, non-exploded view of the individual heater module of FIG. 3A;

FIG. 3C is a perspective backside, non-exploded view of the individual heater module of FIG. 3A; and

FIGS. 4A, 4B, and 4C are planar, cutaway views of the heater of FIG. 1 showing representative orientations of the heater modules therein.

### DETAILED DESCRIPTION

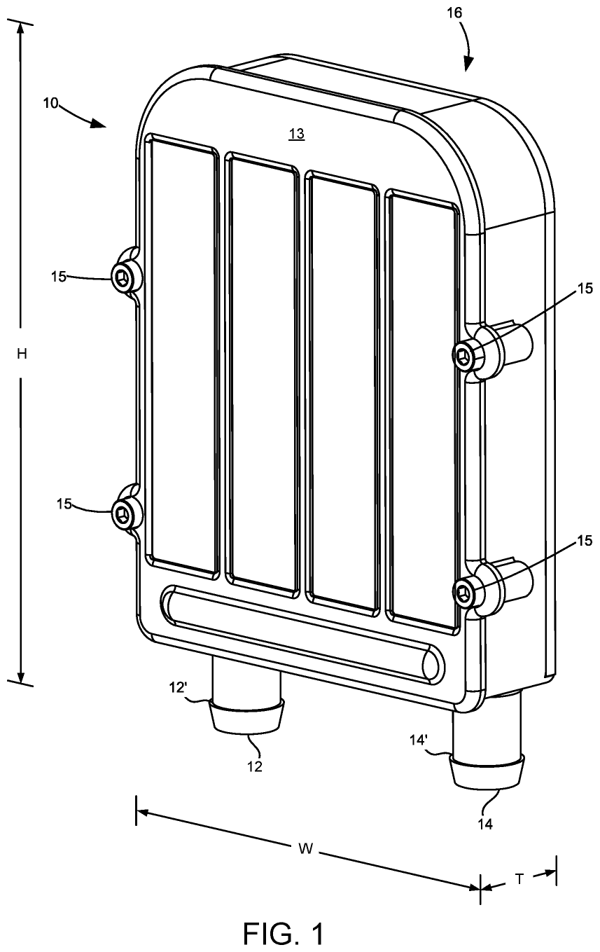

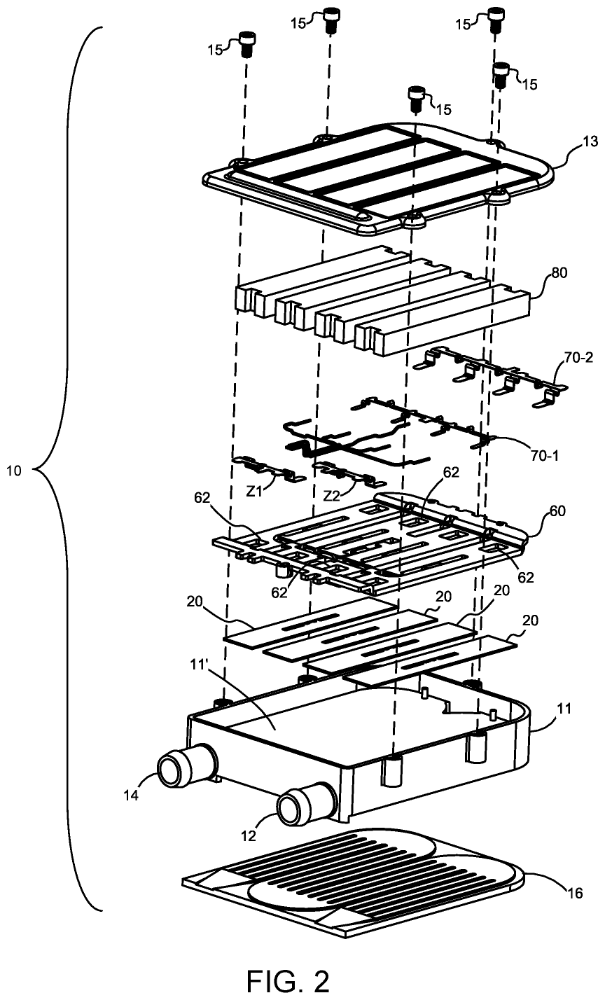

With reference to FIGS. 1 and 2, a heater for a battery powered vehicle (not shown) includes a heat exchanger 10 for heating air in the passenger cabin of the vehicle. The exchanger 10 has a body 11 with a depth 11′ for containing or housing elements of the heat exchanger. The body typifies a cast aluminum alloy composition. Other materials include, but are not limited to, corrosion resistance materials. A top lid 13 and bottom lid 16 secure with screws 15 the contents inside the body 11 of the heat exchanger. Relative dimensions of the heat exchanger body and lids vary per application, but one instance defines a height H at 200 mm, width W at 150 mm and thickness T at 40 mm. A fluid inlet 12 and outlet port 14 define aspects of the body 11 whereby fluid coolant enters and exits the exchanger. The fluid coolant typifies an antifreeze mixture, such as water glycol. An annular lip 12′, 14′ exists on each of the inlet and outlet to attach the heat exchanger to fluid hoses (not shown) for filling and draining the body 11 with fluid coolant during use.

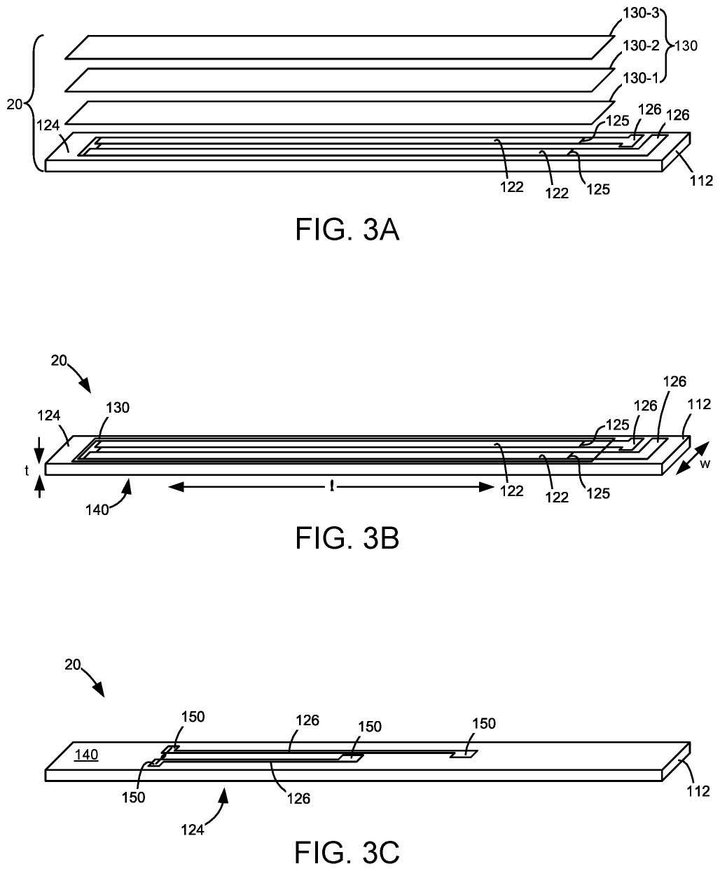

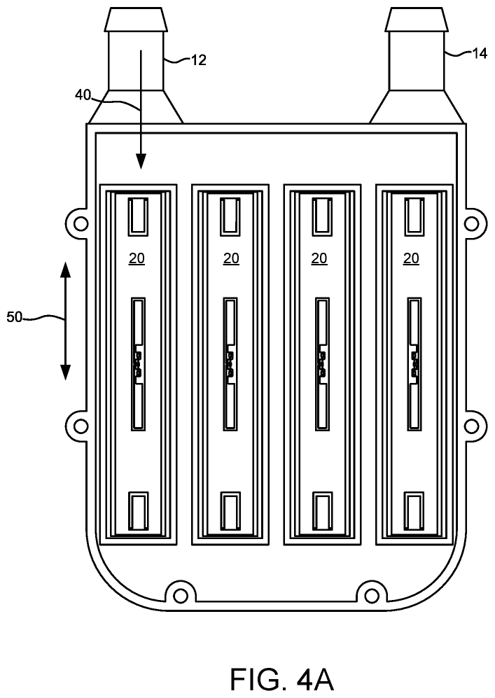

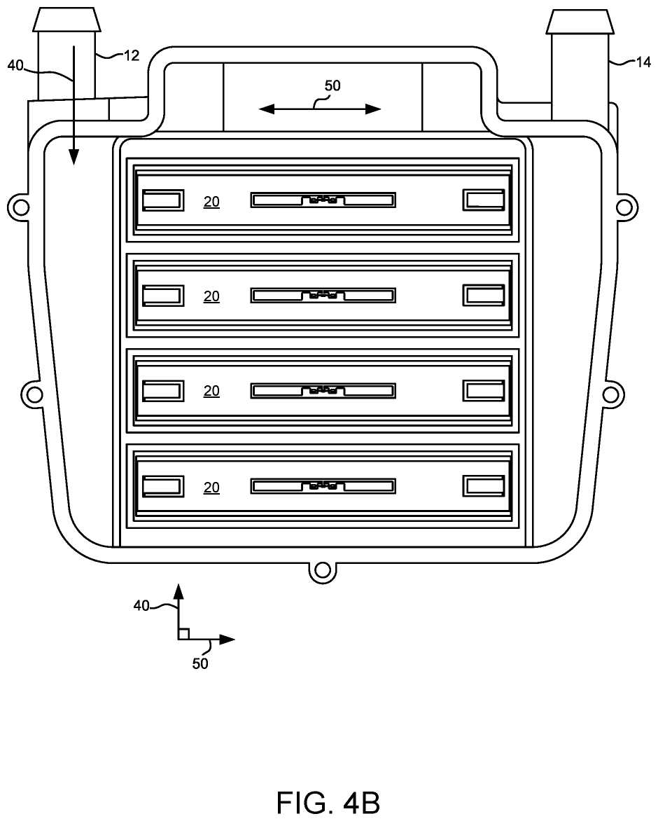

With reference to FIG. 2, the heat exchanger further includes one or more heater modules 20 to heat the fluid coolant. The modules, in this instance, range from one to four in quantity and are generally parallel to one another inside the depth 11′ of the body 11 of the exchanger 10. During use, each module generates about 1.37 kw of energy for a total of about 5.5 kw (˜1.37 kw×4) when four modules are in use. The modules connect electrically to the batteries of the battery powered vehicle which generate anywhere from 240-500 volts (dc) during use. The heater modules are also capable of a power density as high as 730 w/in². FIGS. 3A and 3B show each module 20 in further detail. They include a base in the form of an elongate substrate support 112 with one or more lengthwise resistive heater traces 122 along a side thereof. Each trace, when powered, is capable of generating the powers noted.

In composition, the base 112 is an essentially pure alumina (Al₂O₃) or aluminum nitride (AlN) substrate. This means a base that is at least 95% pure with 5% impurities or less, but preferably about 99% pure with equal to or less than 1% impurities. Impurities to be avoided in either embodiment includes polybrominated biphenyl (PBB), polybrominated diphenyl ether (PBDE), hexabromocyclododecane (HBCDD), polyvinyl chloride (PVC), chlorinated paraffin, certain phthalates, cadmium, hexavalent chromium, lead and mercury. The shape of the base is variable but includes a longitudinally extending solid of a generally rectangular shape having thickness (t), length (l), and width (w) dimensions. Representative dimensions include a thickness in a range of about 0.5-0.7 mm, a length in a range of about 150-160 mm, and a width in a range of about 6-8 mm.

Each heater module 20 also includes at least one resistive trace 122 on a topside 124 of the base. A conductor 126 connects to each resistive trace at interface 125. During use, the conductor 126 receives power from the vehicle batteries to power the resistive trace(s) 122. In turn, the resistive trace heats and provides heating to the heat exchanger to heat the fluid coolant for a cabin heater in an electric or hybrid vehicle. In dimensions, the thickness of the resistive trace is about 10-13 μm with a length of about 135-145 mm and a width of about 4.5-5.5 mm. The conductor has a thickness of about 9-15 μm with a length of about 11-13 mm, and a width of about 4.8-5.8 mm. Also, the resistive trace has a resistance of about 10-12 ohms at 195° C. The resistive trace is formed from a resistor paste of about 80% silver and 20% palladium while the conductor is formed from a conductive paste of silver and palladium or platinum. In one embodiment, pastes for conductors include content of about 93% silver and about 7% palladium or platinum.

Overlying each resistive trace and at least a portion of the conductor, but not an entirety of the conductor (as it needs to connect to the batteries), are at least three layers of glass 130 (130-1, 130-2, 130-3, FIG. 3A). The glass is any of a variety but the first two consecutive glass layers 130-1, 130-2 are of a first type, while the next layer 130-3 is of a second type. The first type defines a cross glass layer, while the second defines a cover glass layer. Any of the three glass layers define a glass having a viscosity of 100 Pa·s or less. More particularly, the viscosity exists at 90 Pa·s or less, especially 65 Pa·s or less. Glass solid content, on the other hand, exists at 65% or more. Various filler particles optionally accompany the glass, such as thermally conductive filler particles like aluminum oxide to maintain a coefficient of thermal expansion in the underlying layer that closely matches the materials of the resistive layer, conductor layer, and base. Other filler materials include, but are not limited, to metals and nitrides or oxides thereof, such as aluminum, aluminum nitride, or boron nitride. In specific embodiments, the glass is purchased commercially by ID number from AGC, Inc., (formerly the Asahi Glass Company) as seen in Table 1. Some of the relative properties are as follows:

TABLE 1

| AGC, Inc. | Thixotropic | Viscosity | Solid Content |
|---|---|---|---|
| Glass Paste ID | Index | (Pa · s) | (%) |
| AP5717B10 | 2.0-2.4 | 100 | 66 |
| AP5717B13 | 1.6 | 89 | 69 |
| AP5717B14 | 1.4 | 61 | 72 |

A further representative glass from AGC, Inc., is identified commercially as AGC Class Sato 31H. Importantly, this glass is electrically insulative and has a thermal conductivity of 2 W/mK or greater. Heat transfers effectively through the glass from the resistive trace but does not electrically short the traces. In any embodiment, the total glass 130 thickness is about 30 to 40 microns. In individual layers of glass 130-1, 130-2, 130-3, the dimensions of glass include a thickness in a range of about 10-13 μm on the base, a length in a range of about 135-145 mm, and a width in a range of about 4.5-5.5 mm. In one embodiment, the first two consecutive layers 130-1, 130-2 of the at least three glass layers together have a thickness of about 24 μm, with the third layer 103-3 making up the balance of total thickness. Optionally, fourth or more layers of glass may overlie the third layer. Any additional layer(s) will also overlie the base and resistive and conductive layers and is similar in composition to any of the other glass layers.

With reference to FIG. 3C, a bottom or backside 140 of the base 112 optionally includes one or more thermistors 150. They interconnect with a same or different conductor 126 of the topside. They are positioned to measure the temperature of the heater module 20 and the conductor 126 connects the thermistors to external sources to measure, store and control the temperature.

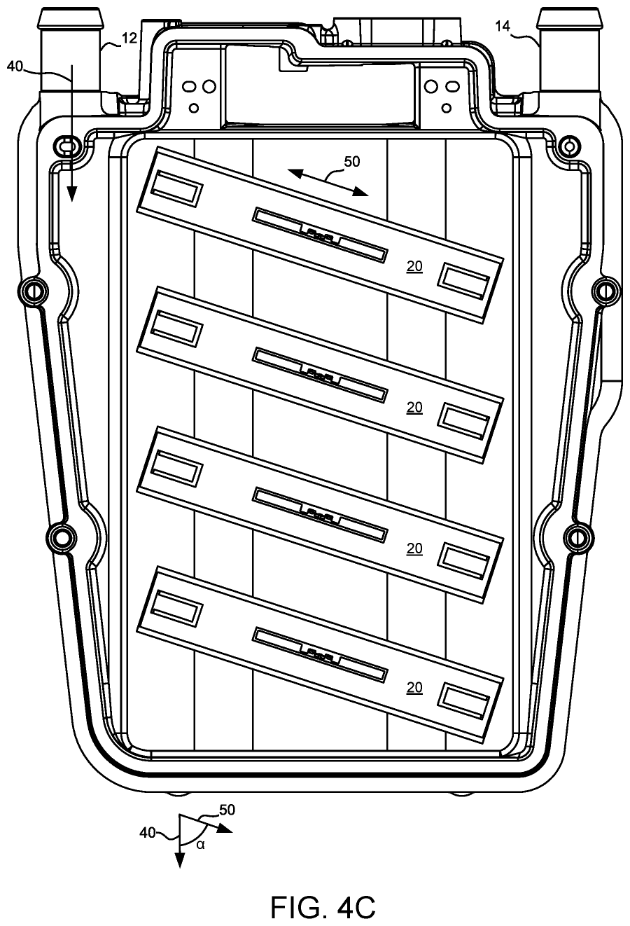

In FIGS. 4A-4C, respectively, the heater modules 20 may be arranged in the body of the exchanger wherein the fluid coolant enters the inlet 12 in a first direction 40 and: wherein a longitudinal extent 50 of the heater modules 20 are substantially parallel to the first direction; wherein the longitudinal extent 50 of the heater modules 20 are substantially perpendicular to the first direction; or wherein the longitudinal extent 50 of the heater modules 20 are substantially angled (\acute{α}) about 30-60 degrees to the first direction. In this manner, the heater modules can provide different functionality and manufacturability.

With reference back to FIG. 2, further contents of the heat exchanger 10 include a heater housing 60 to secure in place the heater modules 20 within the body 11 of the heat exchanger. The housing has a corresponding number of stations 62 to secure in place a same number of the modules 20 (four, in this instance). The stations are spaced apart from one another on the order of about 5-10 mm. A number of electrical connection devices serve to power and ground the thermistors and resistive traces of the heater modules. The devices, labeled as busbars Z1, Z2, 70-1, 70-2 and 70-3, are electrically conductive materials, e.g., copper/phosphor-bronze, formed into shapes and sizes suitable for reaching and contacting the appropriate leads and common lines of the thermistors and resistive traces. Next, a foam structure 80 is placed in the body of the exchanger to keep a mechanical load on the heater modules during use. As is known, heater modules are prone to bowing when energized because of thermal expansion properties of glass on the substrate. In turn, the foam keeps to an acceptable range the bowing of the modules. The foam is any of a variety, but silicone has been found to work suitably. Key aspects of this design that differentiate it from earlier heat exchangers include, but are not limited to, a small form factor of heater modules that has allowed a reduction in the volume of the heat exchanger body by ˜42%.

Generically, heater modules may be constructed by way of thick film printing. In one embodiment, resistive traces are printed on a fired (not green state) ceramic substrate, which includes selectively applying a paste containing resistor material to the base through a patterned mesh screen with a squeegee or the like. The printed resistor is then allowed to settle on the base at room temperature. The ceramic substrate having the printed resistor is then heated at, for example, approximately 140-160 degrees Celsius for a total of approximately 30 minutes, including approximately 10-15 minutes at peak temperature and the remaining time ramping up to and down from the peak temperature, in order to dry the resistor paste and to temporarily fix resistive traces in position. The ceramic substrate having temporary resistive traces is then heated at, for example, approximately 850 degrees Celsius for a total of approximately one hour, including approximately 10 minutes at peak temperature and the remaining time ramping up to and down from the peak temperature, in order to permanently fix the resistive traces in position. Conductive traces are then printed on the ceramic substrate, which includes selectively applying a paste containing conductor material in the same manner as the resistor material. The ceramic substrate having the printed resistor and conductor is then allowed to settle, dry and fire in the same manner as discussed above with respect to resistive traces in order to permanently fix the conductive traces in position. Glass layers are then printed in substantially the same manner as the resistors and conductors, including allowing the glass layers to settle as well as drying and firing the glass layers. In one embodiment, glass layers are fired at a peak temperature of approximately 810 degrees Celsius, slightly lower than the resistors and conductors. Thermistors are then mounted to the base in a finishing operation with the terminals of the thermistor being directly welded to the earlier-formed conductive traces. Thick film printing resistive traces and conductive traces, in this manner, on fired a ceramic substrate provides more uniform resistive and conductive traces in comparison with conventional ceramic heaters, which include resistive and conductive traces printed on a green state ceramic. The improved uniformity of resistive traces and conductive traces provides more uniform heating across contact surfaces as well as more predictable heating.

Preferably, heater modules are produced in an array for cost efficiency. Individual heater modules are singulated after the construction of all heater modules is completed, including firing of all components and any applicable finishing operations. In some embodiments, individual heater modules are separated from the array by way of fiber laser scribing. Fiber laser scribing tends to provide a more uniform singulation surface having fewer microcracks along the separated edge in comparison with conventional carbon dioxide laser scribing.

In other embodiments, thermistors are not directly attached to the substrate but are instead held against a face of the substrate by a mounting clip (not shown) or other form of fixture or attachment mechanism. ASM cables or wires are connected to (e.g., directly welded to) respective terminals of the thermistors to electrically connect them to, for example, control circuitry.

As artisans will appreciate, a great variety of shapes and sizes of heater modules can be produced using the foregoing methods. One approach for providing ceramic heater modules for multiple applications is to size the heater modules to be a close match to the heated area required. However, for larger sized heating applications, this approach can become cost prohibitive. The larger the substrate, the higher the accompanying material cost, including the additional materials needed for printing the resistor and conductor circuits. Inks and pastes made of precious metals such as silver, platinum, and palladium are relatively expensive. Thus, minimizing the size needed for application is highly preferable. Furthermore, it is highly preferable to standardize size and shape. Thick film printing manufacturing yields higher quality and improved cost when fully automated. In even further embodiments, oxidizing or plasma treating the surface of the base further contributes to eliminating the deleterious effects of nitrogen out-gassing during later instances of firing the base which occurs during print, dry, and firing sequences of thick film printing. Advantages of the designs herein should be now readily apparent to those skilled in the art.

The foregoing description of several structures and methods of making the same has been presented for purposes of illustration. It is not intended to be exhaustive or to limit the claims. Modifications and variations to the description are possible in accordance with the foregoing. It is intended that the scope of the invention be defined by the claims appended hereto.

1. A heater for a passenger cabin, comprising:
a body having an inlet and outlet for fluid coolant;
at least one heater module inside of the body to heat the fluid coolant,
the at least one heater module having an elongate substrate support supporting a lengthwise resistive heater trace along a side thereof.

2. The heater of claim 1, wherein the elongate substrate support is at least 95% pure alumina.

3. The heater of claim 2, wherein the elongate support substrate is at least 95% pure aluminum nitride.

4. The heater of claim 1, wherein the elongate substrate supports at least one layer of glass.

5. The heater of claim 1, further including a thermistor supported by the elongate support structure to measure heat generated by the resistive heater trace.

6. The heater of claim 1, wherein the elongate support structure supports pluralities of resistive heater traces, each commonly electrically connected to one another.

7. The heater of claim 1, wherein there are at least two said heater modules.

8. The heater of claim 7, wherein the fluid coolant enters the inlet in a first direction and the at least two said heater modules are substantially parallel to the first direction.

9. The heater of claim 7, wherein the fluid coolant enters the inlet in a first direction and the at least two said heater modules are substantially perpendicular to the first direction.

10. The heater of claim 7, wherein the fluid coolant enters the inlet in a first direction and the at least two said heater modules are angled about 45 degrees to the first direction.

11. A heater for a passenger cabin, comprising:
a body having an inlet and outlet for fluid coolant;
a top and bottom lid covering the body to retain the fluid coolant in the body; and
at least one heater module inside of the body to heat the fluid coolant,
the at least one heater module having an alumina base having equal to or less than 5% impurities,
at least one longitudinally extending resistive trace on the alumina base and a conductor on the alumina base electrically connected to the at least one resistive trace to apply an external voltage to the at least one resistive trace for heating, and
at least three glass layers overlying the at least one resistive trace.

12. The heater of claim 11, wherein the body is cast aluminum.

13. The heater of claim 11, wherein the water coolant is water glycol.

14. The heater of claim 11, wherein the at least one heater module generates about 1.37 kw of energy when the at least one resistive trace is powered by the external voltage.

15. The heater of claim 11, wherein there are four heater modules in parallel with one another.

16. The heater of claim 11, further including foam in the body between the top and bottom lid.

17. The heater of claim 11, further including electrical connection busbars in the body to power the at least one resistive trace.

18. The heater of claim 15, wherein the fluid coolant enters the inlet in a first direction and the four heater modules are substantially parallel to the first direction.

19. The heater of claim 15, wherein the fluid coolant enters the inlet in a first direction and the at four heater modules are substantially perpendicular to the first direction.

20. The heater of claim 15, wherein the fluid coolant enters the inlet in a first direction and the four heater modules are angled about 45 degrees to the first direction.
